(19) United States
(12) Patent Application Publication
(10) Pub. No.: US 2016/0132611 A1
(43) Pub. Date: May 12, 2016

(54) SYSTEM AND METHOD FOR PROVIDING BUSINESS OBJECCT INFORMATION ON WEB PAGES

(71) Applicant: Alibaba Group Holding Limited, George Town (KY)

(72) Inventor: Xiaoqian LIU, Hangzhou (CN)

(21) Appl. No.: 14/937,746

(22) Filed: Nov. 10, 2015

(30) Foreign Application Priority Data
Nov. 10, 2014 (CN) 201410645430.9

(51) Int. Cl. G06F 17/30

(52) U.S. Cl. CPC G06F 17/30893; G06F 17/30905; G06F 17/30882

(57) ABSTRACT

A method of providing business object information on a web page includes the step of providing a web page after receiving a visit request. The web page comprises at least one first area and at least one second area, the first area comprising information of a plurality of target business objects, the second area comprising a plurality of sub-areas, a sub-area of the plurality of sub-areas displaying information of at least one business object. The content corresponding to the web page is determined by, for business objects of each of the sub-areas, obtaining statistics of traffic information for business objects displayed in the sub-areas; determining information of target business objects based upon the statistics; and loading the information of the target business objects into the first area and linking the information loaded to corresponding location in the sub-areas such that, when information of a target business object in the first area is operated upon, the web page is navigated to a location in a sub-area corresponding to the information of the target business object.

### CROSS REFERENCE TO RELATED APPLICATION

This application claims the benefits to Chinese Patent Application No. 201410645430.9, filed on Nov. 10, 2014, which is incorporated herein by reference in its entirety.

### TECHNICAL FIELD

The present invention relates generally to the technologies of processing web page information, and more particularly, to a system and method for providing business object information on web pages.

### BACKGROUND

E-commerce web pages oftentimes face a situation where the loading and displaying of a large amount of information with respect to merchandise brands, business objects and the like render the web pages extremely long. For instance, when a web page is designated to present information for hundreds and thousands of business objects, the web page becomes a web page with extensive content.

A common problem associated with web pages with extensive content is that, in order for a user to browse through such web page to reach the items of interest displayed towards the bottom border thereof, the user needs to either repeatedly scroll a mouse wheel over and over again, or position the cursor on a scroll bar and click on the designated area for the scroll bar multiple times, or drag the scroll bar multiple times. By the same token, content displayed towards the top border of a web page usually has more site exposure, attracting more user visits and generating higher user traffic to the displayed content. On the contrary, content displayed towards the bottom border of a web page has less site exposure, consequently attracting less user visits and generating lower user traffic to the displayed content. Furthermore, when web pages with extensive content partition the information for display into multiple smaller sub-pages, likewise the information displayed in a sub-page with a high sub-page number in the series of the multiple sub-pages yields a less desirable volume in traffic from users.

Further, there is web page content that attracts a large volume of user traffic to the web pages or the web sites hosting the content. For example, materials of large scale promotions presented to consumers on the Internet can generate a huge amount of web page visits in a limited short period of time. As a result, the servers and network resources servicing the web pages of such content experience an increasing amount of visiting loads. On the other hand, for the web page content that attracts relatively a lower volume of user traffic to the web pages or web sites hosting the content, the servers and network resources servicing such web page content experience a small amount of visiting loads, causing not only the waste of network resources, but also system load imbalances.

Therefore, there exists a need to present web pages with extensive content such that information of business objects of more businesses can attract user visits and user interaction upon visit.

### SUMMARY

The present disclosure provides for systems and methods for providing business object information on a web page such that the business objects displayed on the web page gain balanced user traffic thereto, the network resources are utilized more efficiently and the system load imbalances are reduced.

According to an exemplary embodiment of the present disclosure, a method of providing business object information in a web page includes the step of providing a web page after receiving a visit request. The web page includes at least one first area and at least one second area, the first area containing information of a plurality of target business objects, the second area containing a plurality of sub-areas, a sub-area of the plurality of sub-areas displaying information of at least one business object. The content corresponding to the web page is determined by, for business objects of each of the sub-areas, obtaining statistics of traffic information for business objects displayed in the sub-areas; determining information of target business objects based upon the statistics; loading the information of the target business objects into the first area and linking the information loaded to the corresponding location in the sub-areas such that, when information of a target business object in the first area is operated upon, the web page is navigated to a location in a sub-area corresponding to the information of the target business object.

According to another exemplary embodiment of the present disclosure, a method of providing business object information in a web page includes the step of receiving a web page. The web page includes at least one first area and at least one second area, the first area containing information of a plurality of target business objects, the second area containing a plurality of sub-areas, a sub-area of the plurality of sub-areas displaying information of at least one business object. The content corresponding to the web page is determined by, for business objects of each of the sub-areas, obtaining statistics of traffic information for business objects displayed in the sub-areas; determining information of target business objects based upon the statistics; loading the information of the target business objects into the first area and linking the information loaded to the corresponding location in the sub-areas such that, when information of a target business object in the first area is operated upon, the web page is navigated to a location in a sub-area corresponding to the information of the target business object.

According to yet another exemplary embodiment of the present disclosure, a user interface method of providing business object information based on a web page includes the step of displaying a web page. The web page includes at least one first area and at least one second area. The second area contains a plurality of sub-areas, a sub-area of the plurality of sub-areas displaying information of at least one business object. The first area contains information of a plurality of target business objects, which is linked to the corresponding location in the sub-areas such that, when information of a target business object in the first area is operated upon, the web page is navigated to a location in a sub-area corresponding to the information of the target business object.

According to still yet another exemplary embodiment of the present disclosure, a system for providing business object information in a web page includes a displaying module configured for displaying a web page, which includes at least one first area and at least one second area. The second area contains a plurality of sub-areas, a sub-area of the plurality of sub-areas displaying information of at least one business object. The first area contains information of a plurality of target business objects, which is linked to the corresponding location in the sub-areas such that, when information of a target business object in the first area is operated upon, the web page is navigated to a location in a sub-area corresponding to the information of the target business object.

According to yet another exemplary embodiment of the present disclosure, a system for providing business object information in a web page is configured to provide a web page after receiving a visit request. The web page includes at least one first area and at least one second area, the first area containing information of a plurality of target business objects, the second area containing a plurality of sub-areas, a sub-area of the plurality of sub-areas displaying information of at least one business object. The content of the web page is determined by use of an information statistic module and a layout module. The information statistic module is configured to include a traffic information statistic sub-module and a target business object determination sub-module. The traffic information statistic sub-module is configured for, for business objects of the sub-areas, obtaining statistics of traffic information for business objects displayed in the sub-areas. The target business object determination sub-module is configured for determining the information of target business objects based upon the statistic. The layout module is configured for loading the information of the target business objects into the first area and linking the information loaded to corresponding location in the sub-areas such that, when information of a target business object in the first area is operated upon, the web page is navigated to a location in a sub-area corresponding to the information of the target business object.

According to still yet another exemplary embodiment of the present disclosure, a system for providing business object information in a web page is configured to receive a web page. The web page includes at least one first area and at least one second area, the first area containing information of a plurality of target business objects, the second area containing a plurality of sub-areas, a sub-area of the plurality of sub-areas displaying information of at least one business object. The content of the web page is determined by use of an information statistic module and a layout module. The information statistic module is configured to include a traffic information statistic sub-module and a target business object determination sub-module. The traffic information statistic sub-module is configured for, for business objects of the sub-areas, obtaining statistics of traffic information for business objects displayed in the sub-areas. The target business object determination sub-module is configured for determining the information of target business objects based upon the statistic. The layout module is configured for loading the information of the target business objects into the first area and linking the information loaded to corresponding location in the sub-areas such that, when information of a target business object in the first area is operated upon, the web page is navigated to a location in a sub-area corresponding to the information of the target business object.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a flow chart of an exemplary method of providing business object information on a web page in accordance with an embodiment of the present disclosure;

FIG. 2 is an illustration of an exemplary layout of a web page for providing business object information in accordance with an embodiment of the present disclosure;

FIG. 3 is an illustration of another exemplary layout of a web page for providing business object information in accordance with an embodiment of the present disclosure; and

FIG. 4 is a block diagram of a system for providing business object information on a web page in accordance with an embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the disclosure do not inherently indicate any particular order nor imply any limitations in the disclosure.

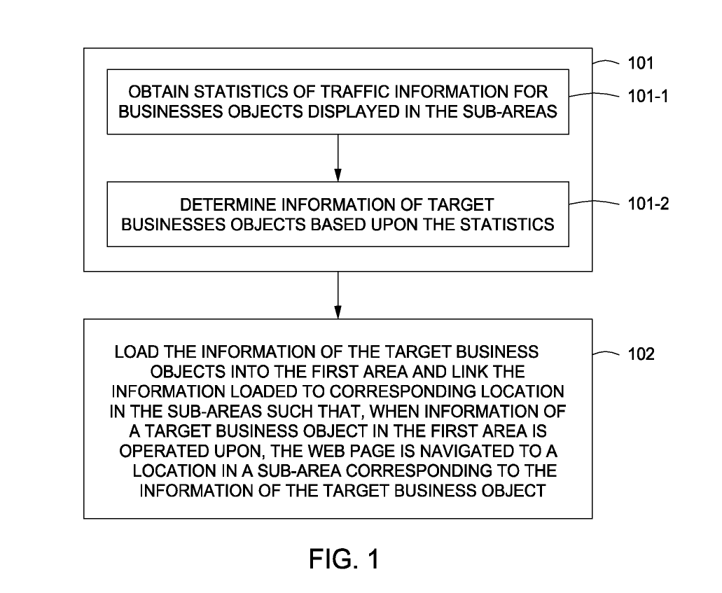

Embodiments of the present disclosure are discussed herein with reference to FIGS. 1-4. However, those skilled in the art will readily appreciate that the detailed description given herein with respect to these figures is for explanatory purposes as the disclosure extends beyond these limited embodiments.

Web pages herein refer to full or partial web pages associated with URLs or any form of content display rendered for user interfaces on devices including but not limited to conventional computers, portable devices, mobile devices, compact devices, and etc.

Embodiments of the present disclosure can be implemented with both a client system and a server system. The server system can be configured to determine the content and the layout thereof for display on a web page. A client system can be configured to execute commands from a user, sending web page display requests to the server system, downloading the web page from the server system and displaying requested web pages in the client's web page display system in a web browser. The following illustrates exemplary embodiments from the perspective of a server system, a client system, and an overall system as well.

Referring to FIG. 1, a flow chart of an exemplary method of providing business object information in a web page by a server system is shown in accordance with an embodiment of the present disclosure. After a server hosting the desired web pages receives a web page display request, the server provides the web page for downloading by the user at the client end. The web page includes at least one first area and at least one second area. The second area includes multiple sub-areas, each of which displays information for at least one business object. The first area includes information regarding multiple target business objects.

In particular, the web page includes at least one first area and at least one second area in order to provide information for business objects contained in the web page with higher site exposure and increased user traffic, balancing system loads and enhancing resource usability. The first area of the web page typically is configured to be positioned atop the second area, which displays information for business objects contained within the web page. The second area of the web page typically occupies the largest display of the entire web page and can be referred to as the “main content area.” The information corresponding to the business objects displayed in the second area includes but is not limited to information such as images and/or text. By use of hyperlinks and other mechanism alike, when a user clicks (i.e., selects by a mouse input device) on such information for a particular business object, the user can activate the hypertext link associated with the information and navigate to other web pages such as, for example, the detailed informational web page for such business object.

The second area, due to the fact that the amount of information for business objects displayed on the web page typically is very large, can be partitioned into multiple sub-areas, each of which displays information for a portion of the business objects out of all the business objects. The layout of the sub-areas within the second area of the web page can vary. In some instances, the sub-areas can be displayed on the web page without overlapping with each other in a manner such as, for example, the sub-areas are displayed horizontally, vertically, or both. Accordingly, when a user browses the web page using a web browser on a client system, the user utilizes controls such as a vertical scroll bar, a horizontal scroll bar, or both to perform browsing control the of the web page.

In some other instances, the sub-areas can be displayed in the second area of the web page in an overlapping arrangement. For example, the second area of a web page can be configured to partition the content thereof into multiple subpages for display. Accordingly, page navigating mechanisms such as the controls of “next page,” “previous page,” etc. are also implemented for the subpages. The user utilizes such controls to browse information for the business objects displayed in the sub-areas. With the above described multiple subpage displaying method, navigation between the subpages by use of the control mechanisms is navigation to different locations within the same web page instead of leading to a different web page in the same web browser or opening up a new windows of the web browser for displaying a different web page.

The first area of the web page displays the information for the target business objects, which are displayed in the second area of the web page and have user traffic information satisfying a pre-determined criterion or criteria. When the information of a target business object in the first area is operated upon by a user, the user does not navigate to web page of a detailed information for the target business object or any other different web pages. Instead, the user navigates within the web page to a location in the second area of the web page corresponding to the information of the target business object. Thus, both the fact that first area of the web page displays the information of business objects with matching user traffic data (e.g., high user clicking rates, etc.) and is presented towards the top border of the web page, and the fact that most users browse a web page starting from the top to the end, information of business objects displayed in the first area of the web page attracts more user attention, thereby generating enhanced user traffic to the information.

After a user selects (i.e., clicks on) the information for a business object displayed in the first area of the web page, the user navigates to the location within the web page in the second area where the information regarding the selected business object is displayed. Because information for other business objects are displayed in the vicinity of the location the user navigates to and it is natural for most users to pay attention to information visible in the field of sight, the information of other business objects surrounding the information of the selected business object can also incur high site exposure and potentially more user traffic to the information displayed.

The server determines the content of both the first area of the web page and the second area of the web page by use of an exemplary method 100. Method 100 starts in step 101, which is performed for all business objects for display in the sub-areas. Step 101 starts in step 101-1, in which the statistics are obtained regarding the information of user traffic to the information of the business object to be displayed in each of the sub-areas. The user traffic information includes but is not limited to information such as clicking rate, complete transaction rate, independent user visits, etc. Statistics regarding the user traffic information can be performed by, for example, obtaining traffic information from the user regarding each of the displayed business object information, analyzing a log recording information such as, for example, clicking events, visiting user information, information for completed transactions, etc., and/or analyzing information of clicking rates, visiting user information etc. collected in real time.

In some embodiments, the server provides an initial web page for a user to download. The initial web page displays information for each of the business objects in any suitable manner such as, for example, in an arrangement of random order or an order according to the categories, brands, etc. of the items offered by the business objects. After the user spends a certain amount of time browsing the initial web page, information can be collected from the user regarding the user traffic to each of the business objects, based on which the user traffic information for each business object can be obtained applying statistical analysis. Alternatively, user traffic information can also be determined based upon the statistics of the user visiting information collected during a period of time such as, for example, the day before, the hour before, or the like. Further alternatively, user traffic information for each of the business object can also be determined by summarizing the statistics of user visiting information generated in the other web pages that display information for the business objects.

In step 101-2, information for target business objects is determined based upon the statistics obtained in step 101-1. On the basis of the user traffic information obtained for each of the business objects, statistics can be computed for the business objects displayed in the sub-areas of the second area of the web page. Such statistics also provide the basis to determine which business objects are the target business objects to be displayed in the first area of the web page.

After step 101-2, the method 100 proceeds to step 102, where information regarding target business objects is loaded into the first area of the web page. The loaded target business object information is further linked to the information for the corresponding locations in the respective sub-areas such that, when information regarding a target business object in the first area is operated upon, the user navigates the web page to a location in a sub-area corresponding to the information of the target business object.

After determining the user traffic information for the business objects in the second area of the web page, information for those business objects with matching user traffic data (e.g., the first certain number of business objects in a ranked series of business objects) will be loaded into the first area of the web page as information regarding the target business objects. Further, the mapping relationship between the information for the target business objects and the corresponding locations in the sub-areas (e.g., coordinates) is stored. Thus, during the user's browsing of the web page, if the user operates on the information of a target business object displayed in the first area, the web page will be navigated to the corresponding location in a corresponding sub-area where the target business object information is displayed. At the same time, potential user traffic to the information of other business objects displayed in the surroundings of the selected target business object information is enhanced.

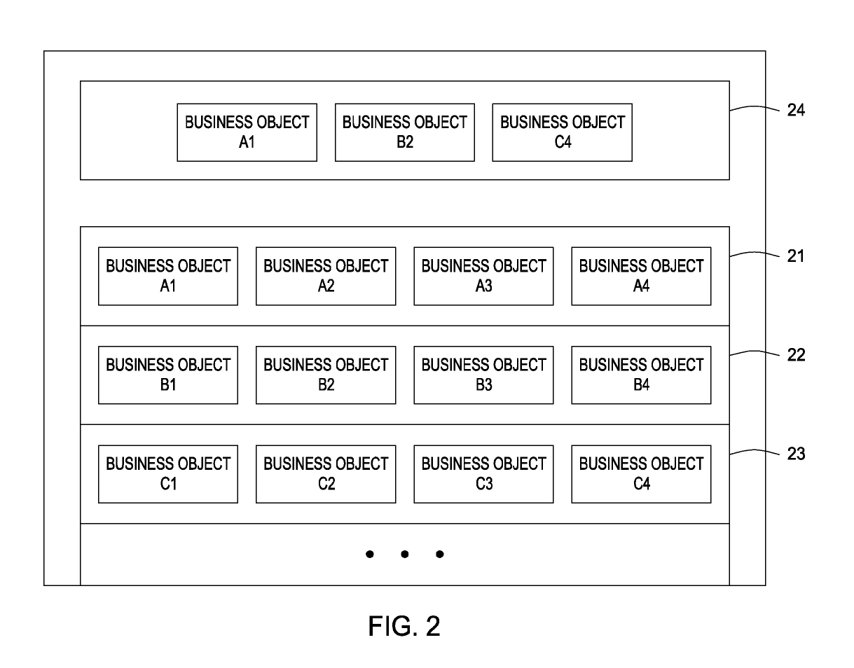

Referring to FIG. 2, an illustration of an exemplary layout of a web page in accordance with embodiments of the present disclosure is shown with respect to how the information of target business objects displayed in the first area can be determined in an exemplary manner. Information of target business objects can be determined in various ways. In this example, web page 200 includes a first area 24 and a second area. The second area includes multiple sub-areas: sub-area 21, sub-area 22, and sub-area 23. Each sub-area displays detailed business object information in forms such as product images, textual descriptions, and/or related hypertext link, etc. Here, sub-area 21 displays information for business objects A1, A2, A3, and A4. Sub-area 22 displays information for business objects B1, B2, B3, and B4. Sub-area 23 displays information for business objects C1, C2, C3, and C4.

In this example, information regarding the target business objects displayed in the first area of the web page can include the information for one or more business objects that are selected from each sub-area and have user traffic information matching a per-determined criterion or criteria (e.g., ranked towards the top of a statistical result). In some embodiments, from each sub-area, a business object generates the highest user visit rate can be selected as the target business object for display in the first area of the web page. As shown here in FIG. 2, the first area 24 displays business object A1, business object B2, and business object C4, which are selected from each corresponding sub-area of the second area. The information regarding those target business objects can be pictorial or textual. When a user operates on the information of a target business object displayed in the first area (e.g., selects with a mouse click), the web page is navigated to a corresponding location in a corresponding sub-area where the detailed target business object information is displayed, thereby increasing the potential user traffic to the information of other business objects displayed in the areas surrounding the target business object information.

Information corresponding to the target business objects displayed in the first area of the web page might be displayed towards the bottom border of the second area of the web page or in a sub-page with a high sub-page sequence number in a sub-page configuration. Without the first area of the web page, regardless of how popular the business object is perceived to be by the users, it is difficult for a user to reach or find this particular business object in the web page. In accordance with embodiments of the present disclosure, information regarding business objects popular with the users is displayed in the first area of the web page, which is positioned towards the top border of the display. When operated by the user, the web page is navigated to the corresponding location in the second area of the web page where the detailed information of the business object is displayed. Thus, it not necessary for the user to repeatedly scroll the web page, scroll the mouse wheel, or navigate the sub-pages in order to quickly access the information of such popular business objects. Consequently, the browsing experience of the users become more convenient with shortened user operation paths, enhancing the potential user traffic to the information of other business objects displayed in the vicinity of the target business objects.

Furthermore, the second area of the web page can be partitioned into multiple sub-areas according to a variety of configurations. In some embodiments, the business objects can be classified into multiple categories such as, for example, men's clothing, women's clothing, jewelry, etc. Information regarding the business objects from the same category is displayed in the same sub-area such that the content appears in a neat and tidy manner. Further, with this configuration, in addition to the in-page navigation from the clicking performed in the first area being enabled, relationships can be further configured for the business objects displayed in the same sub-area to which the web page is navigated. For example, from the perspective of a user interested in one particular business object, it is likely that the user is similarly interested in other business objects from the same category of that particular business object. In other words, category information embodies the preferences of users to a certain extent. Therefore, assisted with the displaying of information for target business objects in the first area of the web page, the user can quickly browsing onto the detailed information of business objects from the categories corresponding to the target business objects, increasing the potential user traffic to the information of those business objects under the respective categories.

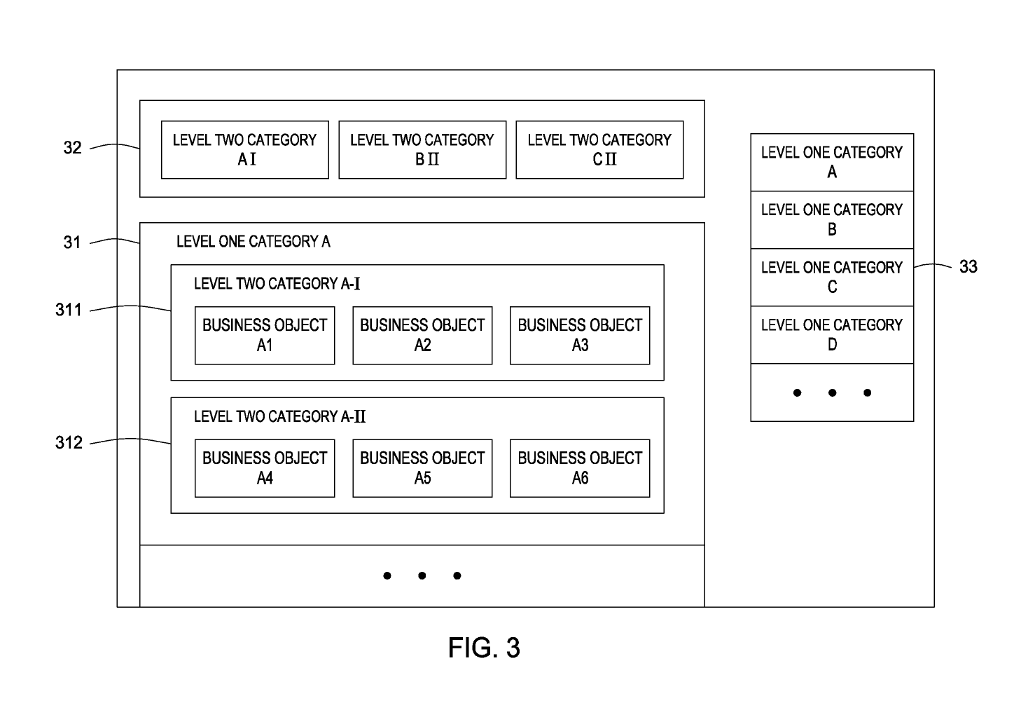

Referring now to FIG. 3, an illustration of another exemplary layout of a web page in accordance with embodiments of the present disclosure is shown with respect to how the information for the target business objects displayed in the first area of the web page can be determined in another exemplary manner. Here, business objects to be displayed on the web page similarly are classified into categories. However, different from the above-described example, the business objects are first classified into multiple level one categories, each of which is further classified into multiple level two categories. The rules based on which the level one categories and the level two categories are classified can either be the same or different. For example, level one categories can include categories such as luggage, cosmetics, watches and jewelry, men's clothing, children's clothing, etc. There can be multiple ways to classify for the level two categories on the basis of the level one categories. In some embodiments, different dimensions are utilized to classify for level two categories on the basis of different level one categories. In some other embodiments, different dimensions are also utilized to classify for level two categories on the basis of the same level one categories. For example, a level one category of “cosmetics” can be further classified into a set of level two categories such as brand A, brand B, and brand C etc. on the dimension of brands. Or, the same level one category of “cosmetics” can also be classified into another set of level two categories such as cosmetic tools, cosmetic counters, etc. In implementations, there are no limitations regarding how to classify the level one categories or the level two categories on the basis of the classified level one categories.

With the classification of level one and level two categories, accordingly the second area of the web page can be partitioned into multiple sub-areas, each of the sub-areas corresponding to a respective level one category, and each of the sub-areas displaying the information of business objects in arrangement according to the level two categories corresponding to the business objects. Accordingly, in a sub-area, each level two category corresponds to a level two sub-area respectively. Those level two sub-areas can also be configured for display in arrangements with or without overlapping amongst the level two sub-areas.

In some embodiments, the second area of the web page can be partitioned along a vertical orientation into multiple sub-areas, each of the sub-areas further being partitioned along a vertical orientation into multiple level two sub-areas and each level two sub-area corresponding to displaying information for business objects under a level two category. As shown in FIG. 3, web page 300 includes a first area 32 and a second area. First area 32 displays level two category A I, level two category B II, and level two category C II. In addition to other sub-areas, the second area of the web page includes a sub-area 31, which is further partitioned into sub-area 311 and sub-area 312. Sub-area 311 displays information for business object A1, business object A2, and business object A3, all from the level two category A I. Similarly, sub-area 312 displays business object A4, business object A5, and business object A6, all from the level two category A II.

Further, in some embodiments, each sub-area can be partitioned into an index or label area and a content area. In a sub-area corresponding to a level one category, in the index area, labels for the level two categories under the level one category are displayed. The labels for the level two categories can also double as a user browsing guide. Upon the user clicking on a corresponding label, the web page will be navigated directly to a location in the level two sub-areas corresponding to the level two category. Titles of the labels can be the same as the tiles of the level two categories, for example, “Brand A,” “Brand B,” “Brand C,” “Cosmetic Tools,” “Cosmetic Counter,” etc. When a label is selected by the user, information for each business object from the level two category corresponding to the selected label is displayed in the corresponding level two sub-area. When another label is selected, information for each business object from another level two category corresponding to the newly selected label is displayed in the level two sub-area.

In some other embodiments, a third area can be provided in addition to the first area and second area to facilitate user browsing. The third area occupies a relatively smaller region of the web page, configured for displaying category information such as the category titles for the level one categories. When level one category information is operated upon, the web page is navigated to the sub-area corresponding to the selected level one category in the second area of the web page. As shown in FIG. 3, web page 300 includes a level one guide area 33 as an exemplary third area. Guide area 33 displays the titles of level one category A, level one category B, level one category C, and level one category D. Such guide area can also display the level one category information in textual and/or other formats (e.g., “luggage,” “cosmetic,” “watches and jewelry,” “men's clothing,” “children's clothing,” etc.). For example, when the item of the category of luggage is operated upon, the web page is navigated to the sub-area corresponding to the level one category of luggage.

With the above-described classification of level one categories and level two categories, the user traffic information for the business objects displayed in the second area of the web page can be determined based on the information of user traffic to the level two categories. In other words, due to the fact that there are business objects from multiple businesses under a level two category the information regarding user traffic to the business objects of those businesses can be collected and compiled such that to determine the user traffic information for respective level two categories. For example, for a level two category including business objects from three businesses, user traffic information corresponding to those three business objects can be compiled by, for example, summing up the user traffic data for the individual businesses to obtain the user traffic information for this particular level two category.

After the user traffic information corresponding to the level two categories is determined, the level two categories having user traffic information that satisfy a predetermined criterion or criteria (e.g., the highest visiting rate) are designated as the information for target business objects. Such target level two categories thereby become the basis for determining how the information for business objects of the businesses is to be loaded into the areas and sub-areas of the web page.

In some embodiments, the information for the target level two categories is loaded into the first area of the web page. As shown in FIG. 3, first area 32 of web page 300 is an exemplary first area for lading target level two category information. The first area 32 includes information for multiple level two categories such that, when a user intends to browse business objects under a particular level two category, the user can click on the corresponding location in the first area of the web page and directly navigate to the locations of the sub-areas of the web page corresponding to the selected level two category, in which information for the business objects of the individual businesses under the selected level two category is displayed.

Information for the level two categories can be loaded into the first area of the web page in various formats. In some embodiments, the category information can be the titles of the level two categories or, in some other embodiments, the category information can be pictures or icons corresponding to the level two categories. Since pictures naturally draw more attention from users, target category information presented this way displays the information in more intuitive and straightforward manner. Pictures representing the level two categories can be obtained in a variety of ways. For example, such a picture can be designated to represent the category in the definition of that category. For another example, such picture can be a picture of a business object having the highest user traffic information under the target category.

With the above described arrangement, as the first area of the web page typically is configured to position towards the top border of the web page for drawing more attention from the users, the information of these target level two categories displayed in the first area of the web page accordingly draw more attention from the users. In some embodiments, as these target level two categories having the highest user visiting rates based on the results of the statistics, the potential more user traffic to those category information is likewise higher. Thus, the displaying of the level two category information in the first area of the web page contributes to attracting users' attention to the information of business objects of the businesses under those level two categories.

In some embodiments, through the statistics of a user's web browsing activities collected from the prior day, it is concluded that level two category of brand A and level two category of brand B have incurred the best visiting rates from the user. Therefore, the category information of those level two categories of brand A and brand B are loaded into the first area of the web page. In some other embodiments, when a particular level two category is classified based on the brands (i.e., in the main content area, at the location corresponding to this level two category, all the information displayed corresponds to the business objects of the businesses selling or representing a same brand), the logo picture or any other attention grabbing information of this particular brand is loaded into the first area of the web page for displaying. In some other alternative embodiments, a picture of a business object having the highest user traffic information under the target category can also be designated as the picture representing this particular level two category.

Furthermore, with the second example of determining the information of the target business objects in the first area of the web page, besides loading the target level two category information in the first area, the target level one category of a level two category can be also be determined based on the information of the level two categories. For example, with a target level two category of brand A, it can be determined that the corresponding target level one category for this particular level two category is the level one category of “Women's Clothing.” While with another a level two category of brand B, it can be determined that it is under the target level one category of “Cosmetics.” As the second area of the web page is partitioned into the sub-areas corresponding to the level one categories, upon determining the target level one category, the sub-areas corresponding to the target level one category can be determined as well. Subsequently, the layout of the information displayed in a sub-area corresponding to a target level one category can be arranged so as to enhance the potential user traffic to the business objects of the other businesses displayed in the web page.

In particular, an exemplary arrangement of a layout for the information of a target level one category in a corresponding sub-area in the second area of the web page is to load the information of business objects of the businesses under the target level two categories in the corresponding sub-areas respectively. In some embodiments, the target sub-area is positioned in a section in the middle of the corresponding sub-area. For example, when the information of the business objects of the businesses under the level two category is displayed in a tile layout as shown in FIG. 3, the information of business objects of the businesses under the target level two category is displayed at the center of the corresponding sub-areas. In particular, with a level one category including 5 level two categories, information of the business objects of the businesses from each level two category business is displayed in a row. When a particular level two category incurs the highest user visits and consequently is designated as a target level two category, the information of the business objects of the businesses from this target level two category is displayed in the third row in the corresponding sub-area. If the corresponding sub-area is configured to include an index area, the index corresponding to the target level two category is displayed in the middle of the index area accordingly.

Thus, when the information of a target level two category is operated on in the first area, the web page is navigated directly to the location where the information of the business objects of the businesses from the selected target level two category is displayed. In other words, the web page is navigated to the center of the target sub-area corresponding to the selected target level two category. Due to users' natural habits to browse information displayed in the vicinity of the area presently being visited, information of business objects of the businesses under other level two categories displayed on top of or next to the target sub-area can have potential user traffic increased as well such that information of business objects of more businesses will be browsed.

As described above, a third area can also be configured in the web page for displaying information of level one categories such as, for example, the titles of the level one categories. When the information of a level one category is operated upon, the web page is navigated to the sub-areas corresponding to the selected level one category in the second area. For example, the web page can be navigated to the top of a corresponding sub-area in the second area.

Further, in order to avoid the situation where some businesses incur too low a user visiting rate, when obtaining statistics of the user traffic information for the level two categories, the user traffic information of at least one level two category that satisfies another pre-configured condition (e.g., lowest user visiting rate) can be determined for each of the corresponding level one categories. The information of the business objects of the businesses under the identified level two categories will be loaded in the top section of the corresponding sub-areas. With such guide functionality of the third area, information of business objects of the businesses displayed in the top section of an area of the web page can expect increased user traffic and user visiting rate. Consequently, user traffic and user visiting rate with regard to the business objects of each of the businesses displayed in the web page becomes more balanced, avoiding the situation where some businesses incur too high a user visiting rate, while the others incur too low a user visiting rate. By the same token, resources can be utilized more efficiently by avoiding the situation where some servers are servicing a high load of display requests while the others are almost idling.

Further, in some embodiments, when configuring the layout for the sub-areas corresponding to the level one categories, the user traffic information regarding the level one categories are also be taken into account. For example, the level one categories with relative low user traffic can be loaded into the sub-areas towards the top border of the web page. Thus, while information of the business objects popular with the users naturally incurs high user visiting rate due to the browsing habits of the users, other information of the business objects less popular with the users can nevertheless incur increased user traffic thereto by the strength of the above described sub-area layout configuration.

In some embodiments, the statistics of the user traffic information regarding the information displayed in the second area can be performed periodically such as, for example, once an hour. Based on the results of the statistical computed periodically for the user traffic information, the layout of the areas and sub-areas of the web page can be updated and adjusted according to the latest statistical data. For example, for the period of time from 8 am to 9 am on a particular day, the first area of the web page displays the level two category A, level two category B and level two category C. For the following period of time from 9 am to 10 am, the first area of the web page instead displays the level two category C, level two category D and level two category E. Accordingly, the information displayed at the center of the corresponding sub-areas changes as well. In other words, statistics can be periodically updated for the user traffic information of the business objects displayed in the sub-areas such that the information of the updated target business are obtained based on the results of the updated statistics. Subsequently, information of the updated target business objects is loaded in the first area of the web page and linked to the corresponding locations in the respective sub-areas. Again, when information of the updated target business objects in the first area is operated upon, the web page is navigated to a location in a sub-area corresponding to the information of the target business objects. Through this dynamic adjustment of the information displayed in the web page, user traffic to business objects of the businesses displayed in the web page gradually gain a balanced distribution.

In some embodiments of the present disclosure, a method of providing business object information in a web page can be illustrated from the perspective of a client. The client sends web page display requests to a server based upon the browsing commands from users, and downloads from the server the requested web pages. The web page includes at least one first area and at least one second area. The second area includes multiple sub-areas, each of which displays information for at least one business object.

The content of the areas and sub-areas of the web page can be determined by performing for each business objects to be displayed in the sub-areas: obtaining statistics of the user traffic information for the business objects displayed in the sub-areas; determining the information of target business objects based upon whether the user traffic information satisfies pre-configured conditions; loading the information of the target business objects into the first area of the web page and linking the information loaded to corresponding location in the sub-areas such that, when information of a target business objects in the first area is operated upon, the web page is navigated to the location in a sub-area corresponding to the information of the target business objects.

Here, after downloading the requested web page, the client can subsequently analyze, process and arrange the content of the web page for the purposes of displaying in a window of a web browser of the client. Such web page can be partitioned into at least one first area and at least one second area, the content of which is determined in manners substantially similar to the pertinent details illustrated in the above described embodiments detailed from the perspectives of a server.

In some other embodiments, an exemplary system for providing information for business objects in a web page is illustrated from the perspective of an overall system. The web page includes at least one first area and at least one second area. The second area of the web page includes a plurality of sub-areas, a sub-area of the plurality of sub-areas displaying information for at least one business object. The first area of the web page includes information for a plurality of target business objects, where the information of the plurality of target business objects is linked to corresponding locations in the sub-areas such that, when information of a target business object in the first area is operated upon, the web page is navigated to a location in the sub-area corresponding to the information of the target business object.

In some embodiments, information for target business objects corresponds to the information for the business objects selected from the corresponding sub-areas and having user traffic information that satisfies a pre-determined criterion or criteria. In some alternative embodiments, a sub-area of the second area of the web page includes information of business objects under a same level one category, the level one category having a plurality of level two categories. The information of the target business objects is the information of the level two categories selected from corresponding sub-areas and having user traffic information that satisfies a pre-determined criterion or criteria.

In particular, the content of the web page can be determined by performing for each business objects to be displayed in the sub-areas: obtaining statistics of the user traffic information for the business objects displayed in the sub-area; determining the information for target business objects based upon whether the user traffic information for the business objects satisfies pre-configured conditions; loading the information for the target business objects into the first area of the web page and linking the information loaded to corresponding location in the sub-areas such that, when information of a target business objects in the first area is operated upon, the web page is navigated to the location in a sub-area corresponding to the information of the target business objects.

The information for the target business objects having user traffic information satisfying pre-configured conditions can be determined in various ways. In some embodiments, a business object with satisfying user traffic information can be selected from each of the sub-areas, and information for such selected business objects can be designated as the information of the target business objects. In some alternative embodiments, when a sub-area of the web page includes information of business objects from a same level one category having a plurality of level two categories, the information of target business objects can be determined by compiling the user traffic information for business objects from the same level two categories such that to determine user traffic information for a level two category. Information for the target level two categories having user traffic information satisfying pre-configured conditions is designated as the information of target business objects.

In other embodiments, information for the target business objects are updated. In particular, first, for the business objects in each of the sub-areas, updated statistics of the user traffic information for the business objects displayed therein is computed. Second, information for the updated target business objects is determined based on the results of the updated statistics of the user traffic information. Subsequently, information of the updated target business objects is loaded in the first area of the web page and linked to the corresponding locations in the respective sub-areas. Again, when information of an updated target business object in the first area of the web page is operated upon, the web page is navigated to the location in a sub-area corresponding to the information of the updated target business objects.

The plurality of sub-areas in the second area of the web page can be configured in layouts of such as, for example, overlapping or non-overlapping arrangement.

In some other embodiments of the present disclosure, a user interface for providing business object information on a web page is provided. The web page includes at least one first area and at least one second area. The second area of the web page has a plurality of sub-areas, a sub-area of the sub-areas displaying information of at least one business object. The first area of the web page includes information of a plurality of target business objects, where the information of the plurality of target business objects is linked to the corresponding location in the sub-areas such that, when information of a target business object in the first area is operated upon, the web page is navigated to the location in a sub-area corresponding to the information of the target business object.

In some embodiments, information for target business objects corresponds to the information for the business objects selected from the corresponding sub-areas and having user traffic information that satisfies a pre-determined criterion or criteria. In some alternative embodiments, a sub-area of the second area of the web page includes information of business objects under a same level one category, the level one category having a plurality of level two categories. The information of the target business objects is the information of the level two categories selected from corresponding sub-areas and having user traffic information that satisfies a pre-determined criterion or criteria.

Pertinent details of the above described embodiments are substantially similar to the embodiments illustrated in the above described embodiments detailed from the perspectives of a server, which is not repeated herein for purposes of simplicity.

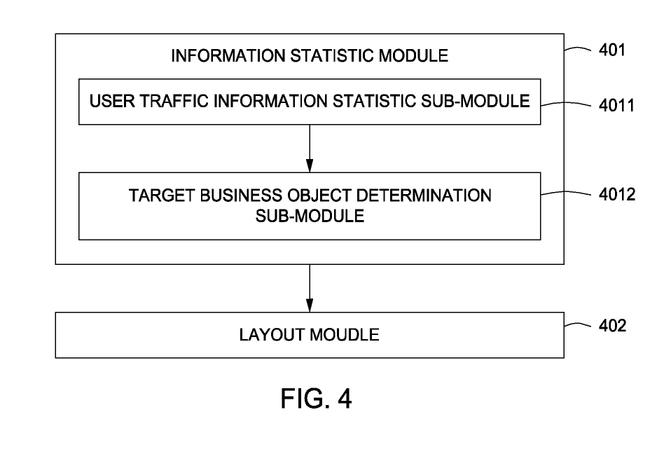

Referring to FIG. 4, a block diagram of an exemplary system for providing business object information in a web page in accordance with embodiments of the present disclosure is shown. The system 400 is configured to provide a web page after receiving a web page request. The web page includes at least one first area and at least one second area. The first area of the web page has information of a plurality of target business objects; the second area of the web page includes a plurality of sub-areas, a sub-area of the sub-areas displaying information for at least one business object. The system 400 includes an information statistic module 401 and a layout module 402. The information statistic module 401 further includes a user traffic information statistic sub-module 4011 and a target business object determination sub-module 4012, both of which are executed for the business objects in each of the sub-areas. The user traffic information statistic sub-module 4011 is configured for obtaining statistics of user traffic information for business objects displayed in the sub-areas. The target business object determination sub-module 4012 is configured for determining information of target business objects based upon the statistical result obtained regarding the user traffic information for the business objects. The layout module 402 is configured for loading the information of the target business objects into the first area of the web page and linking the information loaded to corresponding location in the sub-areas such that, when information of a target business object in the first area of the web page is operated upon, the web page is navigated to the location in a sub-area corresponding to the information of the target business object.

In some embodiments, the target business object determination sub-module 4012 includes a selection sub-module configured for selecting, from each of the sub-areas, a business object having user traffic information that satisfies pre-determined conditions; and a first determination sub-module configured for designating information of the business objects selected from the sub-areas as the information of the target business objects.

In some other embodiments, where each of the sub-areas includes information of business objects from a same level one category having a plurality of level two categories, the target business object determination sub-module 4012 includes a collection sub-module and a second determination sub-module. The compilation sub-module is configured for compiling user traffic information for business objects from the level two categories such that to determine the user traffic information corresponding to the level two categories. The second determination sub-module is configured for designating information corresponding to the target level two categories having user traffic information satisfying a pre-determined criterion or criteria as the information of target business objects.

The second determination sub-module can further include a business object selecting sub-module, a representative picture determination sub-module and an information determination sub-module. The business object selecting sub-module is configured for selecting business objects from the target level two categories. The representative picture determination sub-module is configured for designating pictures of the business objects as representative pictures of the target level two categories. The information determination sub-module is configured for determining information of the target business objects based upon the representative pictures.

In some alternative embodiments, the layout module 402 can be configured for, when determining the content of the webpage, loading information of the business objects from the target level two categories in the middle section of the target sub-area corresponding to the level one category which is the parent category of the target level two categories.

Furthermore, another exemplary system for providing business object information in a web page in accordance with embodiments of the present disclosure is illustrated herein below. The system is configured to receive a web page. The web page includes at least one first area and at least one second area. The first area of the web page has information of a plurality of target business objects; the second area of the web page has a plurality of sub-areas, a sub-area of the plurality of sub-areas displaying information for at least one business object.

The content of the areas and sub-areas of the web page is determined by an information statistic module and a layout module. The information statistic module further includes a user traffic information statistic sub-module and a target business object determination sub-module, both of which are executed for the business objects displayed in each of the sub-areas. The user traffic information statistic sub-module is configured for obtaining statistics of user traffic information for business objects displayed in the sub-area. The target business object determination sub-module is configured for determining the information of the target business objects based upon the statistical result obtained by the user traffic information for the business objects. The layout module is configured for loading the information of the target business objects into the first area of the web page and linking the information loaded to corresponding location in the sub-areas such that, when information of a target business object in the first area of the web page is operated upon, the web page is navigated to the location in a sub-area corresponding to the information of the target business object.

Embodiments of the present disclosure can be implemented using software, hardware, firmware, and/or the combinations thereof. Regardless of being implemented using software, hardware, firmware or the combinations thereof, instruction code can be stored in any kind of computer-readable media (for example, permanent or modifiable, volatile or non-volatile, solid or non-solid, fixed or changeable medium, etc.). Similarly, such medium can be implemented using, for example, programmable array logic (PAL), random access memory (RAM), programmable read only memory (PROM), read-only memory (ROM), electrically erasable programmable ROM (EEPROM), magnetic storage, optical storage, digital versatile disc (DVD), or the like.

It is necessary to point out that, modules or blocks described by embodiments of the present disclosures are logical modules or logical blocks. Physically, a logical module or logical block can be a physical module or a physical block, a part of a physical module or a physical block, or the combination of more than one physical modules or physical blocks. Physical implementation of those logical module or logical blocks is not of essence. The realized functionalities realized by the modules, blocks and the combinations thereof are key to solving the problems addressed by the present disclosure. Further, in order to disclose the novelties of the present disclosure, the above described embodiments do not disclose about those modules or blocks not too related to solving the problems addressed by the present disclosure, which does not mean that the above described embodiments cannot include other modules or blocks.

It is also necessary to point out that, in the claims and specification of the present disclosure, terms such as first and second only are for distinguishing an embodiment or an operation from another embodiment or operation. It does not require or imply that those embodiments or operations having any such real relationship or order. Further, as used herein, the terms “comprising,” “including,” or any other variation intended to cover a non-exclusive inclusion, such that a process, method, article, or apparatus that comprises a list of elements does not include only those elements but may include other elements not expressly listed or inherent to such process, method, article, or apparatus. Absent further limitation, elements recited by the phrase “comprising a” does not exclude a process, method, article, or apparatus that comprises such elements from including other same elements.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable medium used to actually carry out the distribution. The embodiments disclosed herein may also be implemented using software modules that perform certain tasks. These software modules may include script, batch, or other executable files that may be stored on a computer-readable storage media or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to best explain the principles of the disclosure and its practical applications, to thereby enable others skilled in the art to best utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A method of providing business object information in a web page, the method comprising the steps of:
providing a web page after receiving a visit request, the web page comprising at least one first area and at least one second area, the first area comprising information of a plurality of target business objects, the second area comprising a plurality of sub-areas, a sub-area of the plurality of sub-areas displaying information of at least one business object, wherein content corresponding to the web page is determined by:
obtaining statistics of traffic information for business objects displayed in the sub-areas;
determining information of target business objects based upon the statistics; and
loading the information of the target business objects into the first area and linking the information loaded to corresponding location in the sub-areas wherein when information of a target business object in the first area is operated upon, the web page is navigated to a location in a sub-area corresponding to the information of the target business object.

2. The method of claim 1, wherein the step of determining information of target business objects based upon the statistics comprises the steps of:
selecting, from each of the sub-areas, at least one business object having traffic information that satisfies a pre-determined criterion; and
designating information of the business objects selected from the sub-areas as information of target business objects.

3. The method of claim 1, wherein a sub-area of the plurality of sub-areas comprises information of business objects from a same level one category, the level one category comprising a plurality of level two categories, and the determining information of target business objects based upon the statistics comprises the steps of:
collecting traffic information of business objects from level two categories such that to determine traffic information corresponding to the level two categories; and
designating information corresponding to target level two categories as information of target business objects, the target level two categories having traffic information satisfying a pre-determined criterion.

4. The method of claim 3, wherein the step of designating information corresponding to target level two categories as information of target business objects comprises the steps of:
selecting business objects from the target level two categories;
designating pictures corresponding to the selected business objects as representative pictures of the target level two categories; and
determining information of target business objects based upon the representative pictures.

5. The method of claim 3, wherein content corresponding to the web page is further determined by:
loading information of business objects from target level two categories in target sub-areas corresponding to level one categories which are parent categories of the target level two categories.

6. The method of claim 1, wherein the plurality of sub-areas of the second area are displayed without overlapping in the web page.

7. The method of claim 1, wherein the plurality of sub-areas of the second area are displayed with overlapping in the web page.

8. The method of claim 1, further comprising the step of updating information of target business objects, the step comprising, for the businesses of the sub-areas:
updating the statistics of the traffic information of the business objects displayed in the sub-areas;
determining information of updated target business objects, based on the updated statistics of the traffic information; and
loading the information of the updated target business objects in the first area and linking the information of the updated target business objects with corresponding location in the sub-areas such that, when information of a updated target business object in the first area is operated upon, the web page is navigated to a location in a sub-area corresponding to the information of the updated target business object.

9. A user interface method based on a web page, the method comprising:
displaying business object information in a web page, the web page comprising at least one first area and at least one second area, the second area comprising a plurality of sub-areas, a sub-area of the plurality of sub-areas displaying information of at least one business object, the first area comprising information of a plurality of target businesses object, wherein the information of the plurality of target business objects is linked to corresponding location in the sub-areas such that, when information of a target business object in the first area is operated upon, the web page is navigated to a location in a sub-area corresponding to the information of the target business object.

10. The method of claim 9, wherein information of target business objects correspond to information of business objects selected from corresponding sub-areas and having traffic information satisfying a pre-determined criterion.

11. The method of claim 9, wherein a sub-area of the plurality of sub-areas comprises information of business objects from a same level one category, the level one category comprising a plurality of level two categories, and information of target business objects correspond to information of level two categories selected from corresponding sub-areas and having traffic information satisfying a pre-determined criterion.

12. The method of claim 9, wherein content corresponding to the web page is determined by, for business objects of each of the sub-areas:
obtaining statistics of traffic information for business objects displayed in the sub-areas;
determining information of target business objects based upon the statistics; and
loading the information of the target business objects into the first area and linking the information loaded to corresponding location in the sub-areas.

13. The method of claim 12, wherein the determining information of target business objects based upon the statistics comprises:
selecting, from each of the sub-areas, a business object having traffic information that satisfies a pre-determined criterion; and
designating information of the business objects selected from the sub-areas as information of target business objects.

14. The method of claim 12, wherein a sub-area of the plurality of sub-areas comprises information of business objects from a same level one category, the level one category comprising a plurality of level two categories, and the determining information of target business objects based upon the statistics comprises the steps of:
collecting traffic information of business objects from level two categories such that to determine traffic information corresponding to the level two categories; and
designating information corresponding to target level two categories as information of target business objects, the target level two categories having traffic information satisfying a pre-determined criterion.

15. The method of claim 12 further comprising the step of updating information of target business objects, the step comprising, for business objects of each of the sub-areas:
updating the statistics of the traffic information of the business objects displayed in the sub-areas;
determining information of updated target business objects, based on the updated statistics of the traffic information; and
loading the information of the updated target business objects in the first area and linking the information of the updated target business objects with corresponding location in the sub-areas such that, when information of a updated target business object in the first area is operated upon, the web page is navigated to a location in a sub-area corresponding to the information of the updated target business object.

16. A system for providing business object information in a web page, the system comprising:
a processor; and
a non-transitory computer-readable medium operably coupled to the processor, the non-transitory computer-readable medium having computer-readable instructions stored thereon to be executed when accessed by the processor to provide a web page after receiving a visit request, the web page comprising at least one first area and at least one second area, the first area comprising information of a plurality of target business objects, the second area comprising a plurality of sub-areas, a sub-area of the plurality of sub-areas displaying information of at least one business object, the instructions comprising:
an information statistic module comprising:
a traffic information statistic sub-module configured for, for business objects of each of the sub-areas, obtaining statistics of traffic information for business objects displayed in the sub-areas; and
a target business object determination sub-module configured for determining information of target business objects based upon the statistic; and
a layout module configured for loading the information of the target business objects into the first area and linking the information loaded to corresponding location in the sub-areas such that, when information of a target business object in the first area is operated upon, the web page is navigated to a location in a sub-area corresponding to the information of the target business object.

17. The system of claim 16, wherein the target business object determination sub-module comprises:
a selection sub-module configured for selecting, from each of the sub-areas, a business object having traffic information that satisfies s a pre-determined criterion; and
a first determination sub-module configured for designating information of the business objects selected from the sub-areas as information of target business objects.

18. The system of claim 16, wherein a sub-area of the plurality of sub-areas comprises information of business objects from a same level one category, the level one category comprising a plurality of level two categories, and the target business object determination sub-module comprises:
a compilation sub-module configured for compiling traffic information of business objects from level two categories such that to determine traffic information corresponding to the level two categories; and
a second determination sub-module configured for designating information corresponding to target level two categories as information of target business objects, the target level two categories having traffic information satisfying a pre-determined criterion.

19. The system of claim 18, wherein the second determination sub-module comprises:
a business object selecting sub-module configured for selecting business objects from the target level two categories;
a representative picture determination sub-module configured for designating pictures corresponding to the selected business objects as representative pictures of the target level two categories; and
an information determination sub-module configured for determining information of target business objects based upon the representative pictures.

20. The system of claim 18, wherein the layout module is further configured for, when determining content of the web page, loading information of business objects from target level two categories in middle sections of target sub-areas corresponding to level one categories which are parent categories of the target level two categories.
